(19) United States
(12) Patent Application Publication
(10) Pub. No.: US 2026/0338585 A1
(43) Pub. Date: Oct. 29, 2026

(54) USE OF VIBRATIONAL AMPLITUDE AS A QUALITY INDICATOR TO SPEED OF SOUND AUGMENTED CORIOLIS METERS

(71) Applicant: Corvera, LLC, South Glastonbury, CT (US)

(72) Inventor: Daniel Gysling, South Glastonbury, CT (US)

(73) Assignee: Corvera, LLC, South Glastonbury, CT (US)

(21) Appl. No.: 19/122,561

(22) PCT Filed: Oct. 20, 2023
(86) PCT No.: PCT/US2023/077416

§ 371 Date: Apr. 18, 2025

Related U.S. Application Data
(60) Provisional application No. 63/380,284, filed on Oct. 20, 2022.

(51) Int. Cl. G01F 1/37; G01F 1/50; G01F 1/84

(52) U.S. Cl. CPC G01F 1/37; G01F 1/50; G01F 1/8436; G01F 1/845

(57) ABSTRACT

A method is disclosed which may include measuring a speed of sound of a process fluid by interpreting an output of an array of at least two pressure sensors. In addition, the method may include determining a damping metric associated with the at least one vibrating flow tube. The method may include utilizing the damping metric to determine a quality metric. Moreover, the method may include utilizing the quality metric to assess confidence in a gas void fraction measurement of the process fluid based at least in part on measured sound speed of the process fluid. A speed of sound augmented Coriolis meter configured to employ such methods is also disclosed.

### CROSS-REFERENCE TO RELATED APPLICATION

This application claims the benefit of U.S. Provisional Patent Application Ser. No. 63/380,284 having a filing date of 20 Oct. 2022. The disclosure of the application above is incorporated herein by reference in its entirety.

### BACKGROUND

The present disclosure relates to the correcting of errors that occur in the measurement of multiphase liquids using Coriolis meters and a measurement of the process fluid sound speed.

Coriolis meters are widely used to measure the mass flow and density of process fluids. Coriolis meters can determine the mass flow and/or density of process fluid by measuring and interpreting the effect of a process fluid on the vibrational characteristic of vibrating, fluid conveying flow tubes. Coriolis meters are typically calibrated to accurately report the mass flow and density of single phase flows. Multiphase flows are well known to impair the accuracy and operability of Coriolis meters. It is well known that Coriolis meters can exhibit errors in reported mass flow, density, and volumetric flow when operating on multiphase process fluids. Under some multiphase conditions, the output of a Coriolis meter can remain repeatable and highly correlated with parameters of the flow. For example, under a fairly wide range of bubbly flow conditions, errors in reported mass flow and density of a Coriolis are primarily associated with the aeroelastic effects associated with increases in the compressibility and/or inhomogeneity of bubbly liquids flowing through the vibrating flow tubes of a Coriolis meter. Several authors have developed models for errors in Coriolis meters operating on bubbly liquids, including Hemp, Gysling and Zhu. Hemp's model, described in the prior art (see Reference 1), offers a concise prior art formulation for these types of errors.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include measuring a speed of sound of a process fluid by interpreting an output of an array of at least two pressure sensors. The method may also include determining a damping metric associated with the at least one vibrating flow tube. The method may furthermore include utilizing the damping metric to determine a quality metric. The method may in addition include utilizing the quality metric to assess confidence in a gas void fraction measurement of the process fluid based at least in part on measured sound speed of the process fluid. Other embodiments of this aspect include corresponding computer systems, apparatus, and computer programs recorded on one or more computer storage devices, each configured to perform the actions of the methods.

Implementations may include one or more of the following features. The method may include determining a parameter of the process fluid utilizing the gas void fraction measurement, the damping metric and at least one measured vibrational characteristic of the at least one vibrating flow tube. The method may include determining the damping metric utilizing an excitation energy metric and a vibration amplitude metric. The method where the at least one parameter of the process fluid is a mass flow rate. The method where the at least one parameter of the process fluid is a density. The method may include determining a weighting factor utilizing the damping metric, inputting a measured process fluid sound speed and the weighting factor into an error correction algorithm, and correcting at least one of a mass flow measurement and a density measurement of the system using the error correction algorithm. The method where the array of at least two pressure sensors has an aperture that spans at least a part of the at least one vibrating flow tube. The method where the array of at least two pressure sensors are installed on a piping network in fluid communication with the at least one vibrating flow tube and where at least of portion of flow rate of the process fluid within the piping network flows through the at least one vibrating flow tube. Implementations of the described techniques may include hardware, a method or process, or a computer tangible medium.

In one general aspect, a method may include measuring a speed of sound of a process fluid. The method may also include determining a damping metric associated with a vibration of the at least one vibrating flow tube. The method may furthermore include utilizing the damping metric as a quality metric for the speed of sound augmented Coriolis meters. The method may in addition include correcting any of a mass flow measurement and a density measurement of the sound speed augmented Coriolis meter using the quality metric. Other embodiments of this aspect include corresponding computer systems, apparatus, and computer programs recorded on one or more computer storage devices, each configured to perform the actions of the methods.

Implementations may include one or more of the following features. The method where the damping metric comprises a ratio of an excitation energy metric to a vibration amplitude metric. The method may include applying an error correction model comprised of one of a neural network, an empirical model trained with a training data set, or a combination thereof. The method may include using the damping metric to assess any of a homogeneity of the process fluid within at least one flow tube of the sound speed augmented Coriolis meter, a repeatability and correlation degree between a measured parameter of the process fluid and a parameter of the process fluid, and an accuracy of the speed of sound of a process fluid in indicating a gas void fraction of the process fluid. The method where the damping metric provides an indication related to any of a measurement of the degree to which the sound speed augmented Coriolis meter has stalled, and a mixedness of the process fluid within the at least one vibrating flow tube. The method may include using the damping metric to perform any of selectively screen data points, and evaluating or determining an applicability or an accuracy of correction models applied to a plurality raw measurements from the sound speed augmented Coriolis meter. The method may include establishing a confidence in any of a reported gas void fraction, a corrected mass flow and a corrected density of the process fluid utilizing metrics including any of an excitation energy metric, and a vibrational amplitude metric. Implementations of the described techniques may include hardware, a method or process, or a computer tangible medium.

In one general aspect, a sound speed augmented Coriolis meter may include a system that measures at least one vibrational characteristic of at least one vibrating flow tube and determines a sound speed measurement of a process fluid and determines at least one parameter of the process fluid. The sound speed augmented Coriolis meter may also include one or more processors configured to measure a speed of sound of a process fluid by interpreting an output of an array of at least two pressure sensors, determine a damping metric associated with the at least one vibrating flow tube, utilize the damping metric to determine a quality metric, and utilize the quality metric to assess confidence in a gas void fraction measurement of the process fluid based at least in part on measured sound speed of the process fluid. Other embodiments of this aspect include corresponding computer systems, apparatus, and computer programs recorded on one or more computer storage devices, each configured to perform the actions of the methods.

Implementations may include one or more of the following features. The sound speed augmented Coriolis meter where the one or more processors are further configured to determine the damping metric utilizing an excitation energy metric and a vibration amplitude metric. The sound speed augmented Coriolis meter where the at least one parameter of the process fluid is any of a mass flow rate and a density. The sound speed augmented Coriolis meter where the one or more processors are further configured to determine a weighting factor utilizing the damping metric, input a measured process fluid sound speed and the weighting factor into an error correction algorithm, and correct at least one of a mass flow measurement and a density measurement of the system using the error correction algorithm. The sound speed augmented Coriolis meter where the array of at least two pressure sensors has an aperture that spans at least a part of the at least one vibrating flow tube. The sound speed augmented Coriolis meter where the one or more processors are further configured to apply an error correction model comprised of one of a neural network, an empirical model trained with a training data set, or a combination thereof. Implementations of the described techniques may include hardware, a method or process, or a computer tangible medium.

### BRIEF DESCRIPTION OF THE DRAWINGS

FIG. 1 is a graphical representation of the excitation energy metric diagnostic for a Coriolis meter as a function of gas void fraction in accordance with the present disclosure;

FIG. 2 is a graphical representation of the flow tube vibrational amplitude metric for a Coriolis meter as a function of gas void fraction in accordance with the present disclosure;

FIG. 3 is a graphical representation of the Coriolis Mass Flowmeter Damping (CMFD) parameter for a Coriolis Meter as a function of gas void fraction in accordance with the present disclosure;

FIG. 4 is a graphical representation of the raw and corrected Coriolis mass measurement for a speed of sound augmented Coriolis as a function of gas void fraction in accordance with the present disclosure;

FIG. 5 is a graphical representation of the raw and corrected Coriolis mass measurement for a speed of sound augmented Coriolis as a function of gas void fraction in accordance with the present disclosure;

FIG. 6 is a side view in partial section of a Coriolis meter in accordance with the present disclosure; and

FIG. 7 is a flowchart of an example process in accordance with the present disclosure.

### DETAILED DESCRIPTION

It is well known that Coriolis meters can exhibit errors in reported mass flow, density, and volumetric flow when operating on bubbly liquids. For the purposes of discussion, it is useful to broadly classify errors in Coriolis meters operating on multiphase flows as either correctable errors or uncorrectable errors based on the degree of difficulty associated with correcting the measured values from the Coriolis meter to accurately reflect parameters of the process fluid. Correctable errors as defined herein are errors in the output of Coriolis meters due to multiphase conditions for which the Coriolis meter continues to report measurements that remain highly-correlated with one or more parameters of the process fluid. For example, errors in which the mass flow reported by a Coriolis meter operating on a multiphase flow remains highly-correlated with the actual mass flow of the process fluid are considered “correctable”. In another example, errors in the density reported by a Coriolis meter operating on a multiphase fluids which remain highly-correlated with the density of the liquid phase of the process fluid are also considered correctable errors. Whereas, errors in the reported mass flow and/or density that are not well-correlated with parameters of the process fluid, such as when a Coriolis meter has stalled, as defined below, would be considered uncorrectable errors.

It is also well known that the introduction of multiphase conditions within a Coriolis meter can impair the ability of a Coriolis meter to maintain sufficient vibrational amplitude of the flow tubes, thereby impairing the operability of a Coriolis meter to accurately and repeatably determine vibrational characteristics of the fluid-conveying flow tubes, and thereby impairing the ability of the Coriolis meter to provide repeatable measurements that are highly correlated with one or more parameters of the process fluid.

Under single phase conditions, Coriolis meters are often designed to maintain the vibrational amplitude of the fluid-conveying flow tubes of the Coriolis meter at a prescribed amplitude. For single phase flows, the vibration of the process fluid-filled flow tubes are typically lightly-damped, and an relatively small amount of energy is required to be delivered to the vibrating flow tubes by the drive electronics within the Coriolis meter to maintain the vibration at a prescribed amplitude. However, under multiphase, gas/liquid conditions, the introduction of a gaseous phase within a continuous liquid phase typically increases the damping associated with the vibrating fluid-conveying flow tubes, thereby increasing the energy required to be input by the drive electronics to maintain a vibration at a prescribed amplitude. The drive electronics of Coriolis meter typically output diagnostics parameters that enable a quantification of the damping (e.g. a damping metric) of the driven vibratory mode, and this damping metric is indicative of the mixedness of the process fluid within the vibration flow tube. In bubbly flow regimes, small levels of gas void fraction typically result in relatively small increases in damping. The drive electronics in a Coriolis meter are often designed to respond to any decrease in vibrational amplitude such as that associated with an increase in the vibrational damping by increasing the excitation energy such that the amplitude of the vibration is maintained. With additional increases in damping due to, for example, increased gas void fraction, the drive electronics increase the excitation energy further to maintain the design vibration amplitude. This process continues with increasing gas void fraction until the drive electronics reach a maximum level of excitation energy. The maximum excitation energy level is typically set by power limitations associated with hazardous area ratings of the Coriolis meter. Thus, although the damping of the fluid-conveying flow tubes increased due to multiphase effects during this process, provided the excitation energy remains below saturation, the amplitude of the vibration remains constant at the design vibration amplitude.

However, once the drive gain is saturated, additional increases in damping, such as due to increases in gas void fraction and/or other effects due to multiphase conditions, result in the vibrational amplitude of the flow tubes decreasing. Eventually, with increasing gas void fraction the damping and other effects due to multiphase conditions can result in the amplitude of the flow tubes being insufficient for the Coriolis electronics to reliable discern vibrational characteristics of the flow tubes, i.e. phase lags in the vibrational mode shape and/or the vibrational frequency of the tubes. Under these conditions, the Coriolis meter is considered to have “stalled”. and the Coriolis meter is typically no longer capable of reporting measurements that are repeatable and highly-correlated to parameters of the process fluid.

It should be recognized that there are other types of control methodologies that can be utilized to control the drive amplitude of Coriolis meters which depart from the widely-used approach described above. It should also be recognized by those skilled in the art that there are many ways to determine a measure of the damping (e.g. determine a damping metric) associated with a vibrating fluid-conveying flow tube. These methods include utilizing a measure of the excitation energy and a measure of the vibrational amplitude. In general, determining damping parameters associated with the vibration of any driven flow tube is readily determined utilizing methods known to those skilled in the art methods are independent of the specific control algorithms utilized drive the vibration of flow tubes of Coriolis meters.

Speed of Sound (SOS) augmented Coriolis technology as disclosed herein has been discovered to correct the output of Coriolis meters operating on bubbly liquids. In one embodiment, speed of sound augmented Coriolis technology utilizes a measurement of the sound speed of the process fluid within the flow tubes of a Coriolis meter and an empirically-informed parametric model to correct for the effects of bubbly liquids on the mass flow and density measurements of a Coriolis meter, calibrated on single phase flows, but operating on a process fluid comprised of bubbly liquids.

In addition to utilizing empirically-informed parametric models to correct for errors in Coriolis meters operating on bubbly flows, other types of models which utilize a measurement of a process fluid sound speed and the output of Coriolis meter to correct for the effects of bubbly liquids can be utilized as well. These other types of models include neural networks and or other types of empirical models that utilize training data sets to train empirical models to predict, and correct for, errors in Coriolis meter and are considered within the scope of the present disclosure. Such other models include those disclosed in co-pending Patent Cooperation Treat application number PCT/US 23/65511 having an international filing date of 7 Apr. 2023, the disclosure of which is incorporated herein in its entirety.

One challenge with methodologies used to correct Coriolis meters is assessing the confidence in the measured parameters, including for example the reported gas void fraction, the corrected mass flow, and the corrected density of the process fluid. As part of the current disclosure, it has been discovered that that such confidence can be established utilizing damping metrics indicative of the damping of the vibrating flow tube. Damping metrics indicative of the damping of the flow tubes can often be readily determined utilizing one or more of 1) an excitation energy metric; and 2) a vibrational amplitude metric. Such damping metrics can be used as useful metrics in the development and application of methodologies which utilize the output of Coriolis meters and a process fluid sound speed to determine one or more parameters of a multiphase fluid.

One embodiment of the current disclosure is use of the ratio of a normalized Coriolis excitation energy metric to a normalized Coriolis vibration amplitude meter, defined herein as the Coriolis Mass Flow Damping (CMFD) parameter (a damping metric) as a quality metric for speed of sound augmented Coriolis meters. (See Reference 4, Zhu, Hao, Application of Coriolis Mass Flowmeters in Bubbly or Particulate Two-Phase Flows, PhD. Thesis, Institute of Fluid Mechanics, University of Erlangen-Nuremberg, Shaker Verlag, 2009).

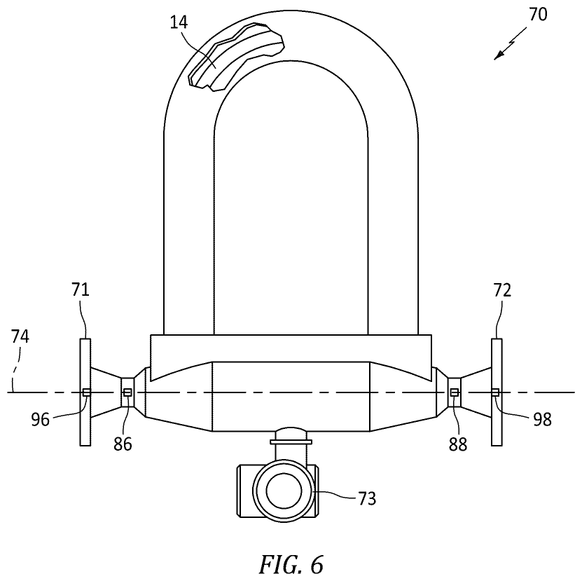

This disclosure teaches the use of a CMFD parameter (a damping metric) as a useful parameter in assessing the confidence in measurements from a speed of sound augmented Coriolis meter and in improving the ability of speed of sound augmented Coriolis technology to accurately interpret the fundamental measurements from a Coriolis meter and an array of pressure sensors 86, 88 with an aperture spanning the flow tubes of the Coriolis meter (FIG. 6). Qualitatively, a CMFD provides 1) an indication of the homogeneity of the process fluid within the flow tubes of Coriolis meter and is a useful indicator for the repeatability and degree to which the measured mass flow and density of a Coriolis meter are correlated to the mass flow and density of the process fluid; and 2) an indication of the degree to which a speed of sound measured by an array of pressure transducers installed on a piping network which either 1) spans the flow tubes of the Coriolis meter, 2) spans a section of the flow tubes of a Coriolis meter, or 3) spans of section of conduit in proximity to, but not including, the flow tubes of Coriolis meter, is indicative of the gas void fraction of the process fluid, all of which, or a portion of which, is flowing through both the conduit with an array of pressure sensors and the vibrating flow tubes of a Coriolis meter. In general, the lower the CMFD associated with a given operating condition of a speed of sound augmented Coriolis meter, the higher the confidence would be in any of the following outputs: mass flow, density, and gas void fraction measurements provided by a speed of sound augment Coriolis meter. For clarity, this disclosure contemplates improvements for a speed of sound augmented Coriolis meters for which the speed of sound measurement may be made on a piping network that 1) either contains the flow tubes of the Coriolis meter or 2) contains regions of a piping network in fluid communication with the flow tubes of the Coriolis meter, or 3) a combination of both.

These improvements in the accuracy and confidence in the output of a speed of sound augmented Coriolis meter due the use of the CFMD are due, in part, to firstly, uncertainty in the mass flow and density measurement of a Coriolis meter tends scale with the CFMD, with the uncertainty increasing with the CFMD. For a CMFD parameter defined as the ratio of an excitation energy metric normalized to unity when the excitation metric is saturated and an vibration energy metric normalized to unity at the design vibration amplitude, this is particularly true for CMFD values greater than unity. For operating conditions for which the CMFD parameters of this type is below unity, the amplitude of the flow tubes is at the design amplitude. Under these conditions, the Coriolis meter can typically measure the fundamental characteristics of the vibration of the flow tubes adequately to provide repeatable determination of the vibrational characteristics of the flow tubes. However, as the CMFD increase above unity, the signal to noise of the measured vibrational characteristics decreases, decreasing the accuracy and repeatability of fundamental measured parameters of the Coriolis meter itself, namely, the phase shift and the natural frequency of the flow tubes. Thus, in this sense the CMFD is a qualitative indication of the degree to which the Coriolis meter have “stalled”. Since the mixedness of gas/liquid process fluids within the vibrating flow tubes is highly correlated with the damping effects on the vibration of the flow tubes conveying the process fluid, the CMFD is a useful indication of the mixedness of the process fluid flowing therethrough, with lower level of the CMFD indicated well mixed conditions.

Secondly, speed of sound augmented Coriolis technology relies in part on having a well-correlated relationship between a measured process fluid sound speed and the gas void fraction of the process fluid flow. As described above, low CMFD values are indicative of well mixed process fluids. For process fluid comprised of well-mixed bubbly flows, the dominant propagation velocity determined from the output of an array of pressure transducers is typically highly correlated with a mixture sound speed that can be related to the gas void fraction with a well-defined relationship, for example, Wood's equation.

However, for other types of less well-mixed two phase flows, such as stratified or slugging flow regimes, the dominant propagation velocity determined from and array of pressure transducers installed on a fluid conveying conduit is, in general, not highly correlated with, nor often representative of, the gas void fraction of a flow. These types of less well-mixed process fluid would tend to have elevated CMFD values when flow through the flow tubes of a Coriolis meter compared to better mixed two phase process fluids. It has been discovered, and as disclosed herein, the CMFD is indicative of a degree to which a measured process fluid sound speed from an array of sensors either spanning or in proximity to the flow tubes of a Coriolis meter is highly correlated with the gas void fraction of the process fluid within the flow tubes of the Coriolis meter.

Prior art which utilizes a process fluid sound speed determined from processing the output from an array of sensors installed on a conduit typically relies on an assumption that the measured sound speed is indicative of the gas void fraction. In prior art embodiments, the measured speed of sound does not provide readily discernable and reliable indications of the mixedness of the process fluid. Thus utilizing a model for the relationship between the process fluid sound speed and the gas void fraction that assumes that the flow is well-mixed (as in the prior art) introduces uncertainty in the interpretation of the measured sound speed in terms of gas void fraction. The methodology disclosed herein teaches the use of a damping metric (for example the CMFD) as a method to assess the degree to which a process fluid comprised of gas and liquid within a conduit (i.e. the flow tubes of a Coriolis meter) is well-mixed, thereby increasing the confidence in the gas void fraction determined from the measured sound speed Increasing the confidence of the gas void fraction measurement itself improves the state of art of measuring gas void fraction, and increasing the confidence of the gas void fraction used in any speed-of-sound-based Coriolis correction methodology that utilizes gas void fraction, improves the state of the art of the speed of sound based Coriolis correction methodology.

Since the CMFD is indicative of both the quality of the Coriolis measurements and the gas void fraction measurement, the CMFD is useful metric with which to gate and/or weight the development and/or application of speed of sound-based Coriolis correction algorithms and correction models wherein such algorithms can include error correction algorithms. It should be appreciated by those skilled in the art that the CMFD can 1) comprise a weighting factor for the input and output parameters in a Coriolis correction algorithm and correction models and 2) be used as input parameters into the correction algorithms and correction models themselves. It is noted that Coriolis damping factors have been used as an input for error correction models for Coriolis meters operating on multiphase flows as described by Wang 2017, however this work does not teach the use of CFMD or similar parameters for assessing the uncertainty of the either measurements of the Coriolis meter or of any speed of sound based gas void fraction. A processor 73 (FIG. 6) can be used in evaluating or determining an applicability or an accuracy of correction models applied to a plurality raw measurements from the sound speed augmented Coriolis meter.

It is also noted that utilizing a Coriolis damping parameter, for example a CMFD, as a weighting or gating parameter in the develop and application of methods to correct for the output parameters of a speed of sound augmented Coriolis meter is a manifestation of utilizing the damping parameter to assess the confidence of the input measurements such as the measured vibrational characteristics and the measured process fluid sound speed.

It is noted in this disclosure that a speed of sound augmented Coriolis meter may be utilized to provide measurements that include any of the following: a mass flow, a density, a gas void fraction, and volumetric flow.

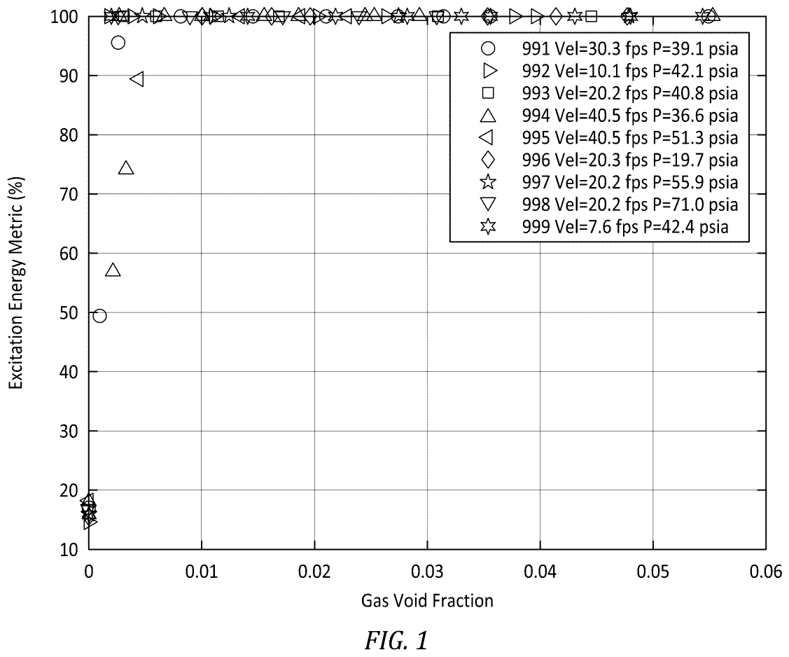

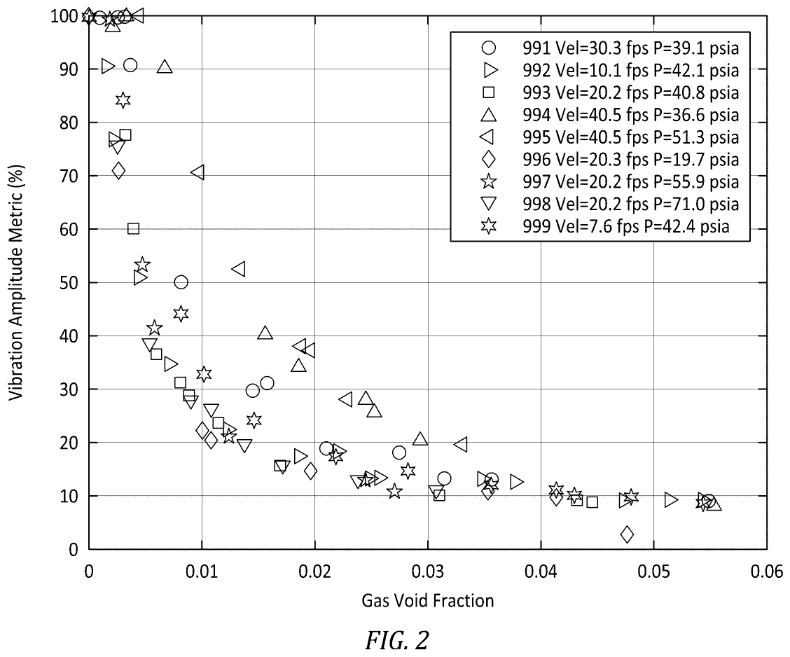

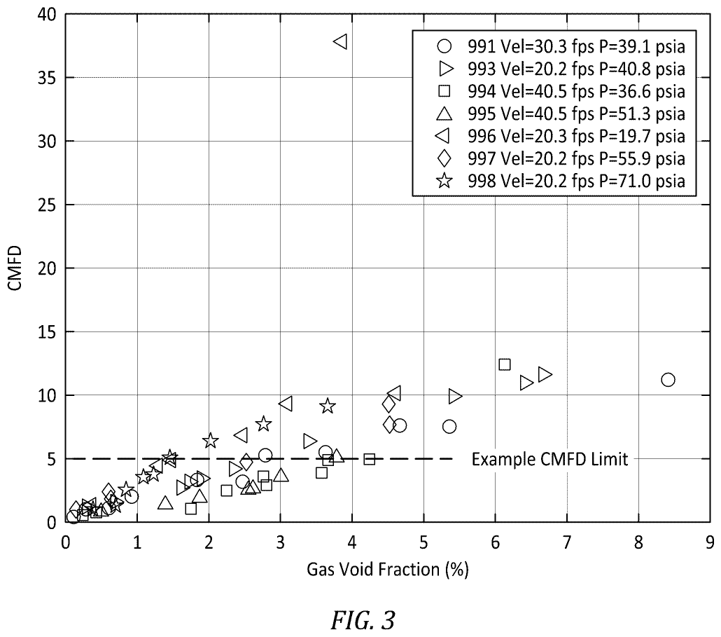

Referring to FIGS. 1 and 2, there is shown the excitation energy metric, and the vibrational amplitude metric respectively for a Coriolis meter operating on bubbly mixtures over a range of gas void fraction and mixture flow velocities. The data presented in FIGS. 1 and 2 (as well as FIG. 3) is for a process fluid comprised of a water/air mixture in sets of constant nominal mixture velocity and constant nominal pressure with varying gas void fraction. The gas void fraction on the x-axis is the gas void fraction determined from a sound speed measurement from an array of two pressure sensors 86, 88 spanning the flow tubes of the Coriolis meter 70 (FIG. 6).

As shown, for the Coriolis meter for which the data is shown in FIGS. 1 and 2, the excitation energy metric saturates with the introduction of relatively small gas void fraction (<1% GVF), and the vibration amplitude decreases with increasing gas void fraction after the drive gain saturates.

With reference also to FIG. 3, there is shown the CMFD, a damping metric, defined as the ratio of normalized excitation energy to the normalized vibrational amplitude, for the data points shown in FIGS. 1 and 2. As shown in FIG. 3 the CMFD, in general, increases monotonically with measured gas void fraction for the majority of the data points for each flow condition. For process fluids comprised of bubbly flows, FIG. 3 illustrates that the CMFD typically scales with the gas void fraction for a given set of nominal flow conditions, such as flow rate and pressure. However, for a given gas void fraction, the CMFD typically scales inversely with the degree of mixedness of the flow fields, with lower CMFD associated with the more well-mixed flows, and higher CMFD's for less well-mixed flows. As shown, for a given gas void fraction, the flow conditions with the higher nominal mixture velocities, indicative of a flow in which the bubbles would be better mixed than flows with lower mixture velocities, has a lower CMFD parameter. For example, at 3% gas void fraction, the flow with a nominal mixture velocity of ~40 ft/sec (having plotted symbols of squares and upright triangles) have lower CMFD's and would be more well-mixed than flows with mixture velocities of ~20 ft/sec (for example, indicated by plotted symbols of stars and left facing triangles).

In this sense, the CMFD is shown to be a measure of the mixedness of a flow and therefore can be used as an indicator of quality of the speed of sound based gas void fraction measurements. An example of a proposed CMFD limit is also illustrated in FIG. 3. As shown, limiting any data set to include only points with CMFD less than a given limit would have the effect of selectively screening out points for which the damping exceeds a given value. For the data set shown in FIG. 3, this screening process effectively screens data points with lower mixture velocities to lower gas void fractions and allows higher flow rate points to higher gas void fractions.

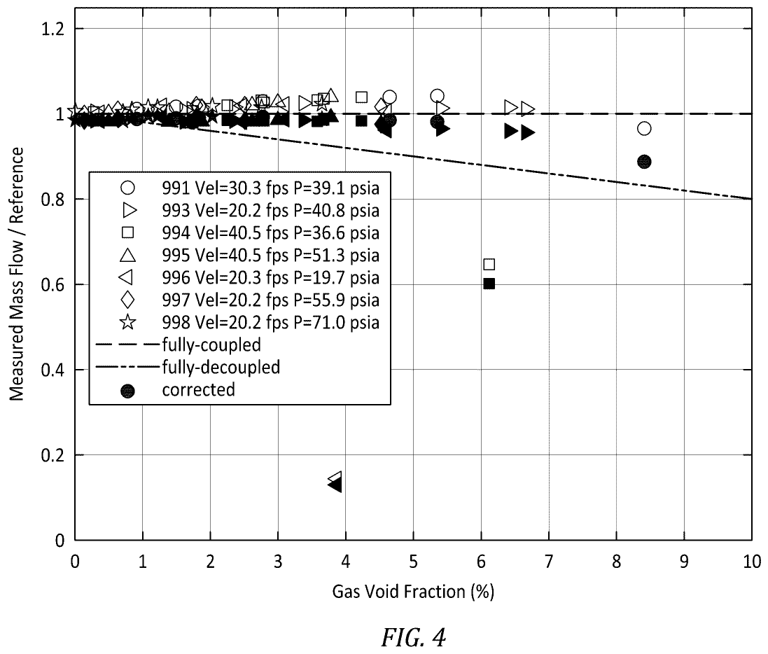

Referring to FIG. 4, there is shown a plurality of raw measurements of the raw mass flow rate reported by a Coriolis meter normalized by the reference liquid mass flow rate as a function of the speed of sound based on the gas void fraction measurement and a speed of sound augmented Coriolis technology corrected mass flow measurement utilizing a method in which all of the data points were used as a training set to optimize parameters in an empirical error correction model to correct for the mass flow, and for which all of the data points were corrected with said model.

Including all the data points in the optimization process admits points for which the CMFD parameters indicated high levels of damping which are likely indicative of not well-mixed flows or other conditions, thus allowing points into the optimization process with relatively low confidence in either 1) the measurements from the Coriolis meter; or 2) the gas void fraction based on a sound speed measured from the array of sensors spanning the flow tubes of the Coriolis meter, or both. The inclusion of these data points with likely uncorrectable data impairs the accuracy of the corrected measurements.

As shown in FIG. 4, that while the model improved the accuracy of many of the mass flow rate measurements, the overall root mean square (RMS) of the data set was not improved by the application of the speed of sound augmented Coriolis technology. The RMS of the raw non-dimensional mass flow data was 0.1147 and the RMS of the SOS augmented Coriolis technology corrected non-dimensional mass flow data was 0.1187. The majority of the errors are associated with data points with relatively large CMFD parameters.

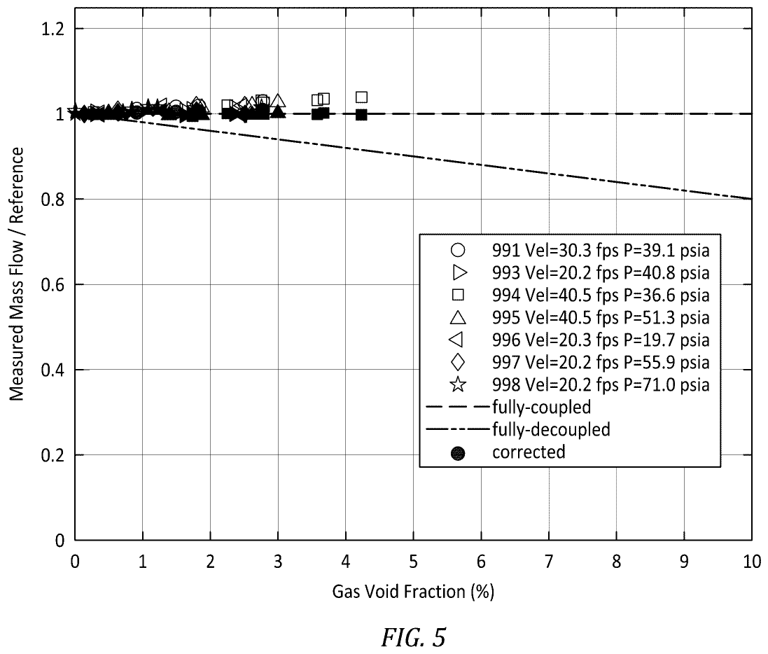

Referring next to FIG. 5, there is shown the results of the application of the same speed of sound augmented Coriolis technology to the data set including only the data points with a CMFD less than 5. Assuming that the excitation energy metric remains saturated at unity for all data points for which the vibration amplitude metric falls below unity, limiting the CMFD to 5 is equivalent to limiting the data points to data points with the vibration amplitude metric is greater than 20%.

It is noted that in the example provided, the CMFD is used to gate the data used in both developing the correlation, i.e. using the training data set for identify parameters in the error correction model that minimizes errors, and to gate the data to which the optimized correlation was applied. In this example, using the CMFD to gate the data is equivalent to applying a weighting factor of unity for data points with a CMFD below the threshold value, and zero for data points with a CMFD above the threshold value. Weighting factors are, in general, not limited to zero or unity and functions that determine their value can take many forms. For example, the data could be weighted as function of max(0,(1-CMFD/5)\hat{ }2), which would have the effect of increasing the weight of the data points with lower CMFD data points over the data points with higher CMFD's compared to the example of gating described herein. This disclosure contemplates the use an any approach in which excitation energy metric data and/or vibrational amplitude metrics are used in determining the relative weighting of measured values from a speed of sound augmented Coriolis meter in the development or application of methods to utilize the output of a speed of sound augmented Coriolis meter to determine a parameter of the flow.

As shown in FIG. 5, the ability of the SOS augmented Coriolis technology to improve the accuracy of the mass flow measurement is greatly increased by gating the data with the CMFD parameter. The SOS augmented Coriolis technology reduced the RMS of the non-dimensional mass flow error from 0.0167 to 0.0038, representing a significant improvement due to the use of the CMFD in the gating of the data used in the training data set, and in gating the data used in the application of the empirically informed parametric model. It should be noted that the non-dimensional mass flow data given in the above example is shown to be “correctable” for data points for which the CMFD exceeded unity significantly, indicating data points for which the excitation energy metric was saturated.

As disclosed herein above, an advancement of the current disclosure over the prior art is achieved by improving the confidence of the corrected mass flow rate to the actual mass flow rate by utilizing the due to the use of the CMFD to restrict the data points to data points for which the flow is more highly mixed. This results in a combination of 1) improved fidelity of the both the repeatability the measured Coriolis parameters and their relationship to the mass flow and density of the bubbly process fluid; and 2) increased fidelity in the gas void fraction determined from the process fluid sound speed measurement, with the combination of the these two effects resulting in improved system accuracy and utility compared to a the application of a similar approach that did not utilize the CMFD as a quality indicator in a model to correct the output of a speed of sound augmented Coriolis meter operating on multiphase flows.

Referring now to FIG. 6, there is shown a schematic of sound speed augmented Coriolis meter 70 suitable for use with methods disclosed herein. As shown, flow tubes 14 are exposed for illustrative purposes. Coriolis meter 70 includes inlet flange 71, outlet flange 72 and transmitter 73. Inlet flange 71 is configured to be coupled to an inlet pipe and outlet flange 72 is configured to be coupled to an outlet pipe. Transmitter 73 includes one or more processors, software and communication screens and ports. Also shown in the figure is centerline 74 drawn through the center of inlet flange 71 and outlet flange 72. In operation, process fluid enters Coriolis meter 70 though inlet flange 71, flows through a flow splitter, and is directed to flow tubes 14 and exits the Coriolis meter through outlet flange 72, after emerging from the flow tubes and being recombined by flowing effectively in reverse through a symmetric flow splitter. It should be appreciated by those skilled in the art that the ability to provide a process fluid speed of sound measurement utilizing only two pressure transducers near the inlet and outlet of a Coriolis meter provides a framework for cost-effective means to implement speed of sound augmented Coriolis meters. It should be further noted that sound speed augmented Coriolis meter 70 provides a measurement of the sound speed of the process fluid mixture as it flows through flow tubes 14. Other prior methods and apparatus either provide an estimate of the sound speed (or gas void fraction) or a measurement outside of the flow tubes 114 of the Coriolis meter. Unsteady pressure sensors 86, 88 form an array having an aperture that spans the vibrating tubes 14 of Coriolis meter 70. Alternative pressure sensors 96, 98 can also be used as an array of pressure sensors spanning the vibrating tubes 14 to determine the speed of sound of a process fluid within Coriolis meter 70.

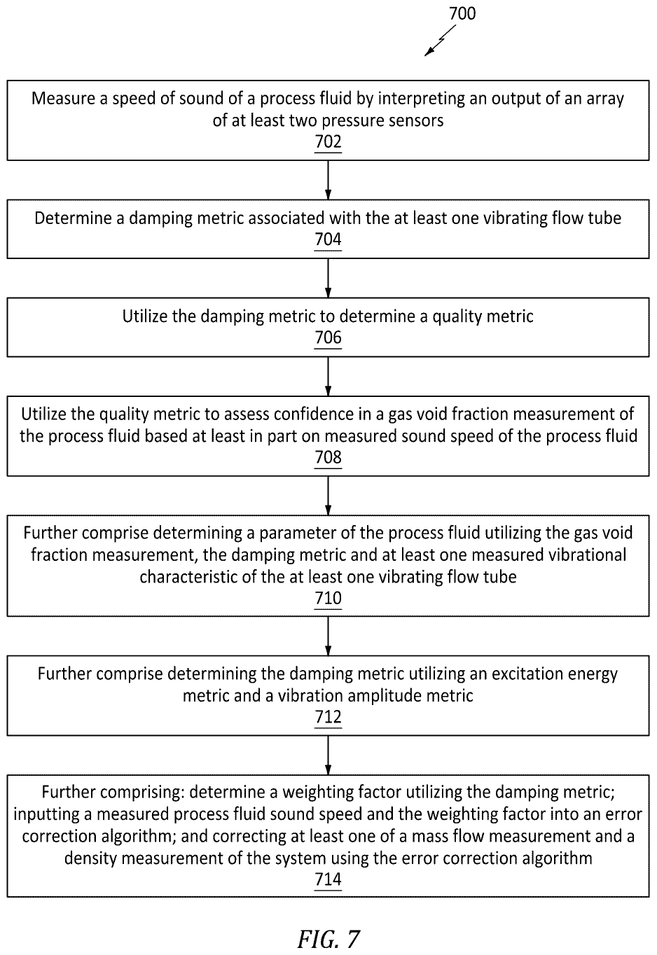

FIG. 7 is a flowchart of an example process 700. In some implementations, one or more process blocks of FIG. 7 may be performed by one or more processors of a speed of sound augmented Coriolis meter.

As shown in FIG. 7, process 700 may include measuring a speed of sound of a process fluid by interpreting an output of an array of at least two pressure sensors (block 702). For example, a speed of sound augmented Coriolis meter may measure a speed of sound of a process fluid by interpreting an output of an array of at least two pressure sensors, as described above. As also shown in FIG. 7, process 700 may include determining a damping metric associated with the at least one vibrating flow tube (block 704). For example, a speed of sound augmented Coriolis meter may determine a damping metric associated with the at least one vibrating flow tube, as described above. As further shown in FIG. 7, process 700 may include utilizing the damping metric to determine a quality metric (block 706). For example, a speed of sound augmented Coriolis meter may utilize the damping metric to determine a quality metric, as described above. As also shown in FIG. 7, process 700 may include utilizing the quality metric to assess confidence in a gas void fraction measurement of the process fluid based at least in part on measured sound speed of the process fluid (block 708). For example, a speed of sound augmented Coriolis meter may utilize the quality metric to assess confidence in a gas void fraction measurement of the process fluid based at least in part on measured sound speed of the process fluid, as described above.

Process 700 may include additional implementations, such as any single implementation or any combination of implementations described below and/or in connection with one or more other processes described elsewhere herein. In a first implementation, the damping metric and at least one measured vibrational characteristic of the at least one vibrating flow tube.

In a second implementation, alone or in combination with the first implementation, the method of may include determining the damping metric utilizing an excitation energy metric and a vibration amplitude metric.

In a third implementation, alone or in combination with the first and second implementation, the method of further includes determining a weighting factor utilizing the damping metric; inputting a measured process fluid sound speed and the weighting factor into an error correction algorithm; and correcting at least one of a mass flow measurement and a density measurement of the system using the error correction algorithm.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

### REFERENCES

1. Hemp, J., and Kutin, J. “Theory of errors in Coriolis flowmeter readings due to compressibility of the fluid being metered”, Journal of Flow Measurement and Instrumentation, Volume 17, Issue 6, December 2006, Pages 359-369
2. Gysling, D, “An Aeroelastic model of Coriolis mass and density meters operating on aerated mixtures” Journal of Flow Measurement and Instrumentation, Volume 18, Issue 2, April 2007, Pages 69-77
3. Weinstein, Joel, “The Motion of Bubbles and Particles in Oscillating Liquids with Applications to Multiphase Flow in Coriolis Meters”, PhD Thesis, Department of Mechanical Engineering, University of Colorado, 2008
4. Zhu, Hao, Application of Coriolis Mass Flowmeters in Bubbly or Particulate Two-Phase Flows, PhD. Thesis, Institute of Fluid Mechanics, University of Erlangen-Nuremberg, Shaker Verlag, 2009
5. Henry, M., et al., A self-validating digital Coriolis mass-flow meter: an overview, Control Engineering Practice, Volume 8, Issue 5, May 2000, Pages 487-506
6. Wang, L., Et al, Input variable selection for data-driven models of Coriolis flowmeters for two-phase flow measurement, Meas. Sci. Technol. 28 (2017) 035305 (12 pp

What is claimed is:

1. A method for improving a system that determines at least one parameter of a process fluid that measures at least one vibrational characteristic of at least one vibrating flow tube and a process fluid sound speed measurement comprising:
measuring a speed of sound of a process fluid by interpreting an output of an array of at least two pressure sensors;
determining a damping metric associated with the at least one vibrating flow tube;
utilizing the damping metric to determine a quality metric; and
utilizing the quality metric to assess confidence in a gas void fraction measurement of the process fluid based at least in part on measured sound speed of the process fluid.

2. The method of claim 1 further comprising determining a parameter of the process fluid utilizing the gas void fraction measurement, the damping metric and at least one measured vibrational characteristic of the at least one vibrating flow tube.

3. The method of claim 1 further comprising determining the damping metric utilizing an excitation energy metric and a vibration amplitude metric.

4. The method of claim 1 wherein the at least one parameter of the process fluid is a mass flow rate.

5. The method of claim 1 wherein the at least one parameter of the process fluid is a density.

6. The method of claim 1 further comprising:
determining a weighting factor utilizing the damping metric;
inputting a measured process fluid sound speed and the weighting factor into an error correction algorithm; and
correcting at least one of a mass flow measurement and a density measurement of the system using the error correction algorithm.

7. The method of claim 1 wherein the array of at least two pressure sensors are installed on a piping network in fluid communication with the at least one vibrating flow tube and wherein at least of portion of flow rate of the process fluid within the piping network flows through the at least one vibrating flow tube.

8. The method of claim 6 wherein the array of at least two pressure sensors has an aperture that spans at least a part of the at least one vibrating flow tube.

9. A method for correcting measurements of a sound speed augmented Coriolis meter operating on bubbly liquids, comprising:
measuring a speed of sound of a process fluid;
determining a damping metric associated with a vibration of the at least one vibrating flow tube;
utilizing the damping metric as a quality metric for the speed of sound augmented Coriolis meters; and
correcting any of a mass flow measurement and a density measurement of the sound speed augmented Coriolis meter using the quality metric.

10. The method of claim 9 wherein the damping metric comprises a ratio of an excitation energy metric to a vibration amplitude metric.

11. The method of claim 9, further comprising applying an error correction model comprised of one of a neural network, an empirical model trained with a training data set, or a combination thereof.

12. The method of claim 9, further comprising using the damping metric to assess any of:
a homogeneity of the process fluid within at least one flow tube of the sound speed augmented Coriolis meter;
a repeatability and correlation degree between a measured parameter of the process fluid and a parameter of the process fluid; and
an accuracy of the speed of sound of a process fluid in indicating a gas void fraction of the process fluid.

13. The method of claim 9, wherein the damping metric provides an indication related to any of:
a measurement of the degree to which the sound speed augmented Coriolis meter has stalled; and
a mixedness of the process fluid within the at least one vibrating flow tube.

14. The method of claim 9, further comprising using the damping metric to perform any of:
selectively screen data points; and
evaluating or determining an applicability or an accuracy of correction models applied to a plurality raw measurements from the sound speed augmented Coriolis meter.

15. The method of claim 9, further comprising:
establishing a confidence in any of a reported gas void fraction, a corrected mass flow and a corrected density of the process fluid utilizing metrics including any of:
an excitation energy metric, and
a vibrational amplitude metric.

16. A sound speed augmented Coriolis meter comprising:
a system that measures at least one vibrational characteristic of at least one vibrating flow tube and determines a sound speed measurement of a process fluid and determines at least one parameter of the process fluid;
one or more processors configured to:
measure a speed of sound of a process fluid by interpreting an output of an array of at least two pressure sensors;
determine a damping metric associated with the at least one vibrating flow tube;
utilize the damping metric to determine a quality metric; and
utilize the quality metric to assess confidence in a gas void fraction measurement of the process fluid based at least in part on measured sound speed of the process fluid.

17. The sound speed augmented Coriolis meter of claim 16, wherein the one or more processors are further configured to determine the damping metric utilizing an excitation energy metric and a vibration amplitude metric.

18. The sound speed augmented Coriolis meter of claim 16, wherein the at least one parameter of the process fluid is any of a mass flow rate and a density.

19. The sound speed augmented Coriolis meter of claim 16, wherein the one or more processors are further configured to:
determine a weighting factor utilizing the damping metric;
input a measured process fluid sound speed and the weighting factor into an error correction algorithm; and
correct at least one of a mass flow measurement and a density measurement of the system using the error correction algorithm.

20. The sound speed augmented Coriolis meter of claim 19, wherein the array of at least two pressure sensors has an aperture that spans at least a part of the at least one vibrating flow tube.

21. The sound speed augmented Coriolis meter of claim 19, wherein the one or more processors are further configured to apply an error correction model comprised of one of a neural network, an empirical model trained with a training data set, or a combination thereof.
